(19) United States
(12) Patent Application Publication
(10) Pub. No.: US 2006/0174231 A1
(43) Pub. Date: Aug. 3, 2006

(54) Method and an apparatus for using code written in a language that is not native to the computer system to invoke a procedure written in a programming language that is native to the computer system

(76) Inventors: Dong Wei, Granite Bay, CA (US); Jerry Huck, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/048,292

(22) Filed: Jan. 31, 2005

(51) Int. Cl. G06F 9/45

(52) U.S. Cl. 717/137

(57) ABSTRACT

Embodiments of the present invention pertain to methods and apparatuses for using code written in a language that is not native to the computer system to invoke a procedure written in a programming language that is native to the computer system are described. In one embodiment, code is created to call a procedure in a manner that cooperates with an operating system that the code executes on. The code is written in a programming language that is not native to the computer system and the procedure is written in a programming language that is native to the computer system. The execution of the code to call the procedure is enabled by transmitting the code to an interpreter that is enabled to interpret the code written in the programming language that is not native. The interpreter is associated with the operating system.

### TECHNICAL FIELD

Embodiments of the present invention relate to programming languages. More specifically, embodiments of the present invention relate to using code written in a language that is not native to the computer system to communicate with a procedure written in a programming language that is native to the computer system.

### BACKGROUND ART

FIG. 1 is a block diagram that depicts a conventional computer system. Conventional computer system 100 has firmware 110 and an operating system 140. Frequently, one part of the firmware 120 is written in a language that is not native to the computer system and another part of the firmware 130 is written in a language that is native to the computer system. Examples of firmware code using languages that are native to the computer system include, but are not limited to, Basic Input Output System (BIOS), System Abstraction Layer™ (SAL™), and Extensible Firmware Interface™ (EFI™.) Examples of firmware code using languages that are not native to the computer system include, but are not limited to, Advanced Configuration and Power Interface™ (ACPI™) Machine Language™ (AML™).

Ideally, implementation of a particular interface can be done either all in the native language or all in the non-native language. For example, ACPI code was written by firmware developers in AML. This code was interpreted by the operating system 140. However, the AML instruction set that was used for creating the code is limited. Some of the functionalities need assistance from the native instructions. This creates a problem with the two parts 120, 130 of the firmware needing to communicate with each other.

One way to enable the two parts of the firmware 120, 130 to communicate involved a platform management interruption mechanism for asynchronously invoking the firmware in native language 130. However, the firmware code running in the platform management interruption is executing behind the back of the operating system. If not carefully managed, this solution at times resulted in the computer system 100 crashing or hang because the operating system 140 may lose timer ticks that is crucial for its operation.

Therefore for these and other reasons, there is a need for an apparatus and a method for allowing the firmware in non-native language 120 to communicate with the firmware in native language 130. This would overcome the limitation of the instruction set in non-native language 120. Further, there is a need for an apparatus and a method for allowing the firmware in non-native language 120 to communicate with the firmware in native language 130 that does not result in the computer system 100 crashing or hang.

### DISCLOSURE OF THE INVENTION

Embodiments of the present invention pertain to methods and apparatuses for using code written in a language that is not native to the computer system to invoke a procedure written in a programming language that is native to the computer system are described. In one embodiment, code is created to call a procedure in a manner that cooperates with an operating system that the code executes on. The code is written in a programming language that is not native to the computer system and the procedure is written in a programming language that is native to the computer system. The execution of the code to call the procedure is enabled by transmitting the code to an interpreter that is enabled to interpret the code written in the programming language that is not native. The interpreter is associated with the operating system.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram that depicts a conventional computer system.

FIG. 2 is a block diagram of an exemplary system for using code (e.g., CCP) that is in a non-native programming language to invoke a procedure that is in a native programming language, according to embodiments of the present invention.

FIGS. 3 and 4 depict examples of code that can be used for creating the CCP, according to embodiments of the present invention.

FIG. 5 depicts a flowchart for creating the CCP and for enabling the execution of the CCP, according to one embodiment of the present invention.

FIG. 6 depicts a flowchart that illustrates the execution of the CCP, according to another embodiment of the present invention.

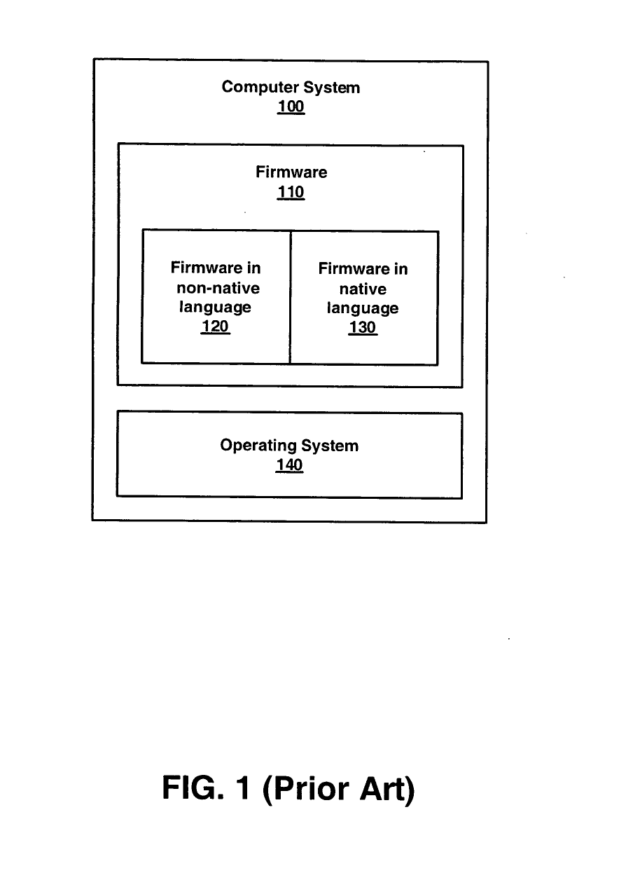

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Software System and Functional Overviews

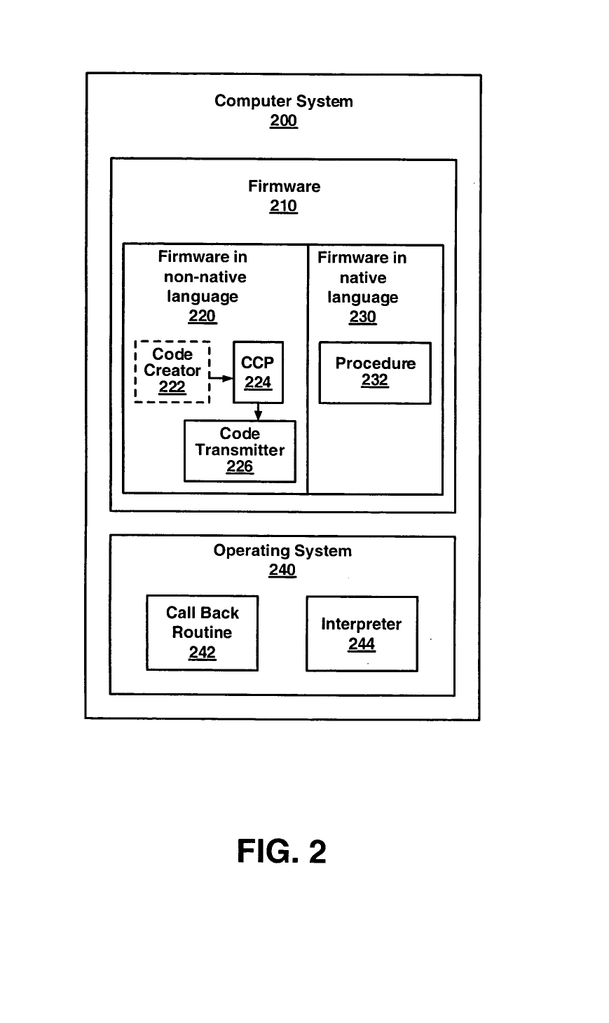

FIG. 2 is a block diagram of an exemplary system for using code that is in a non-native programming language to invoke a procedure that is in a native programming language, according to embodiments of the present invention. The blocks in FIG. 2 can be arranged differently than as illustrated, and can implement additional or fewer features than what are described herein. Further, the features represented by the blocks in FIG. 2 can be combined in various ways.

As depicted in FIG. 2, the computer system 200 includes firmware 210 and an operating system 240. The firmware 210 has a part 220 that is written in a non-native language and another part 230 that is written in a native language. The firmware in non-native language 220 further includes a code creator 222, code to call a procedure 224 (CCP) and a code transmitter 226. The firmware in native language 230 includes a procedure 232. The operating system 240 includes a call back routine 242 and an interpreter 244. The operating system 240 can be Hewlet Packard's Unix™ (HP-UX™). To enable the two parts of the firmware 220, 230 to communicate, the operating system 240 can intermediate communications between the CCP 224 and the procedure 232, for example, by using then optional code creator 222, the code transmitter 226, the interpreter 244 and the call back routine 242, among other things, as will become more evident.

### The Firmware

The firmware 210 has a part 220 that is written in a non-native language and another part 230 that is written in a native language. Examples of languages that are native to the computer system 200 include, but are not limited to, BIOS, SAL, and EFI. Examples of languages that are not native to the computer system 200 include, but are not limited to, AML.

The CCP 224 is associated with the firmware in non-native language 220 and, therefore, is written in a non-native language, according to one embodiment, whereas the procedure 232 is associated with the firmware in native language 230 and, therefore, is written in a native language, according to another embodiment. To enable the two parts 220, 230 of the firmware 210 to communicate, the operating system 240 can intermediate communications between the CCP 224 and the procedure 232, for example, by using the optional code creator 222, the code transmitter 226, the interpreter 244 and the call back routine 242, among other things.

### The Code Creator

The code creator 222 can be software that creates the CCP 224. Alternatively, a program developer can manually perform the function of the code creator 222 by manually writing the CCP 224.

### The Code to Call Procedure (CCP)

The CCP 224 can be written in a language that is not native to the computer system 200, such as AML. Therefore, according to another embodiment, the CCP 224 can be what is known as an ACPI control method. Further, the CCP 224 can be interpreted.

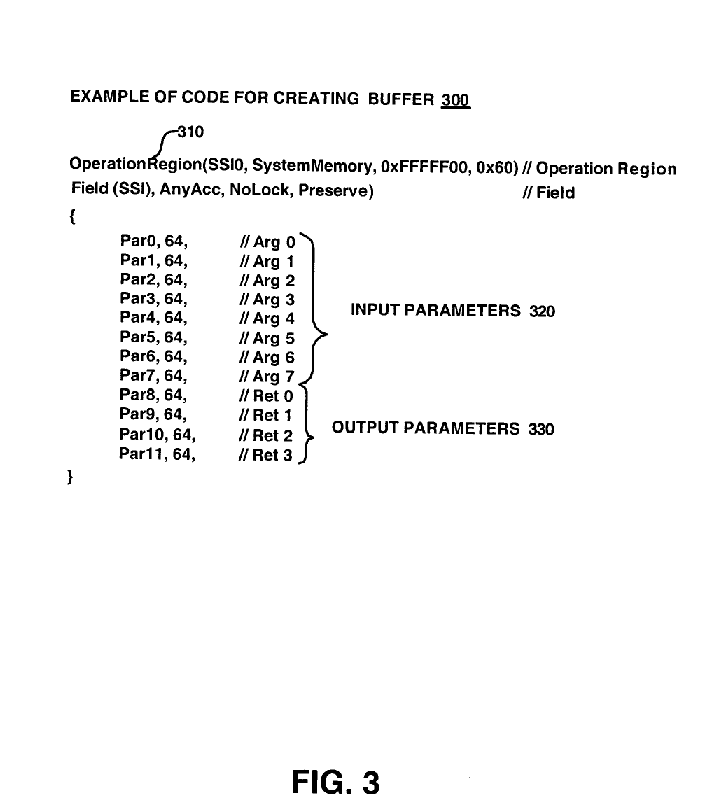

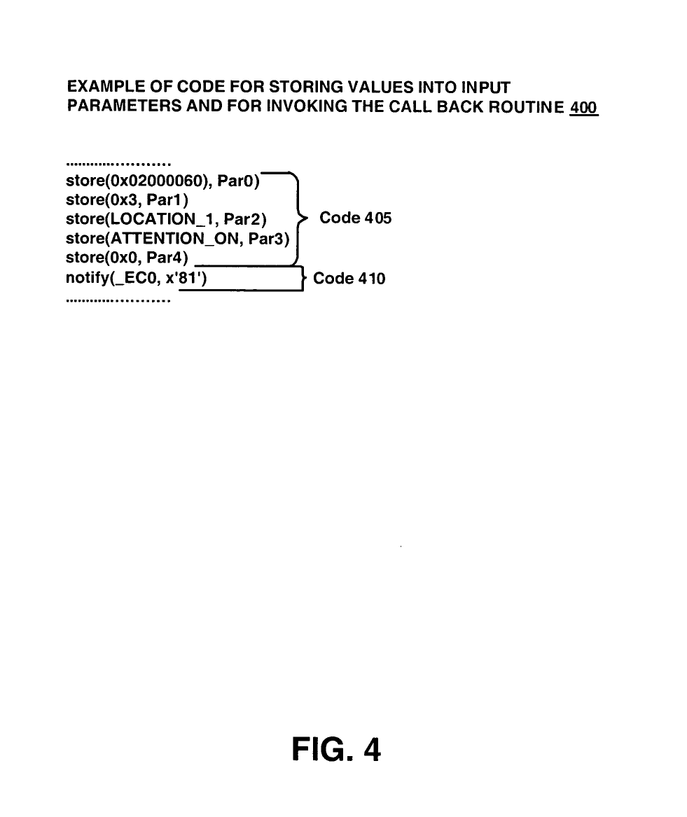

FIGS. 3 and 4 depict examples of code 300, 400 that can be used for creating the CCP 224, according to embodiments of the present invention. For example, the CCP 224 can include code to create a buffer as depicted in example of code 300 (FIG. 3) and the CCP 224 can include code to store values into the input parameters 320 and to invoke the call back routine 242, as depicted in example of code 400. Example code 405 (FIG. 4) depicts instructions for storing values into input parameters 320 (FIG. 3) and example code 410 (FIG. 4) depicts an instruction for invoking the call back routine 242.

Since the CCP 224 is used for calling the procedure 232, the CCP 224, according to one embodiment, can include instructions for communicating with the procedure 232. More specifically, since the procedure 232 can be in a native language, such as SAL, the CCP 224 can include instructions that conform to the calling convention of the native programming language that the procedure 232 uses, such as the IA-64 Software Calling Convention that a procedure 232 written in SAL uses. In this case, the example code for creating a buffer 300 (FIG. 3) can conform to the SAL Software Calling Convention that designates an operational region 310 with 8 parameters (e.g., PAR0-PAR7) to pass values into the procedure 232 and 4 parameters (e.g., PAR8-PAR11) to receive values from the procedure 232. PAR0-PAR7 shall be referred to as input parameters 320 and PAR8-PAR11 shall be referred to as output parameters 330. Further, according to the Software Calling Convention that SAL uses, each parameter (e.g., PAR0-PAR11) is 64 bits long and therefore, the execution of the example of code for creating a buffer 300 would result in creating a buffer that is 96 bytes long.

Example code 410 (FIG. 4) depicts an ACPI notify instruction to an “₁₃ ECO” object that can be used for designating the call back routine 242 and a value “x‘81’” that can be used for designating a request for processing (also commonly known as a “notification value”) from procedure 232. According to one embodiment, example code 410 conforms to the notification convention provided by AML. In this case when the interpreter 244 interprets the value “x‘81’”, the interpreter 244 informs the operating system 240 to invoke the call back routine 242, which in turn makes the call to procedure 232.

### The Interpreter

The code transmitter 226 can transmit the CCP 224 to the interpreter 244, which is associated with the operating system 240. As a result of the interpreter 244 interpreting the CCP 224, the value “x‘81’” to the object “_ECO” associated with code 410 can result in the call back routine 242 being invoked. The interpreter 244 can be written in various programming languages, such as C, and compiled to use the instruction set that the computer system 200 uses.

### The Call Back Routine and the Procedure

The call back routine 242 can be an operating system 240 level routine that can be registered with the operating system 240. For example, if the operating system 240 is Windows™, then the call back routine 242 can be written using Windows™ functions and registered with the Windows™ operating system.

The call back routine 242 can retrieve the values from the input parameters 320 (FIG. 3), invoke the procedure 232, which is designated by the notification value “X‘81’” (refer to example code 410), and pass the values that it retrieved from the input parameters 320 to the procedure 232.

The procedure 232 can retrieve the values that the call back routine 242 passed to it (originating from the input parameters 320) and perform whatever processing is requested. The input parameters 320 (refer to example code 410) can designate the type of processing that the procedure 232 is requested to perform. After the procedure 232 performs processing to satisfy the request based on the values the call back routine 242 passed to the procedure 232, the procedure 232 can return control back to the call back routine 242.

More specifically, the call back routine 242 can store the values that procedure 232 passed to the call back routine 242 into output parameters 330 (FIG. 3). The call back routine 242 can return control back to the CCP 224. The CCP 224 can perform additional processing based on the values from the output parameters 330 if desired.

### OPERATIONAL EXAMPLES

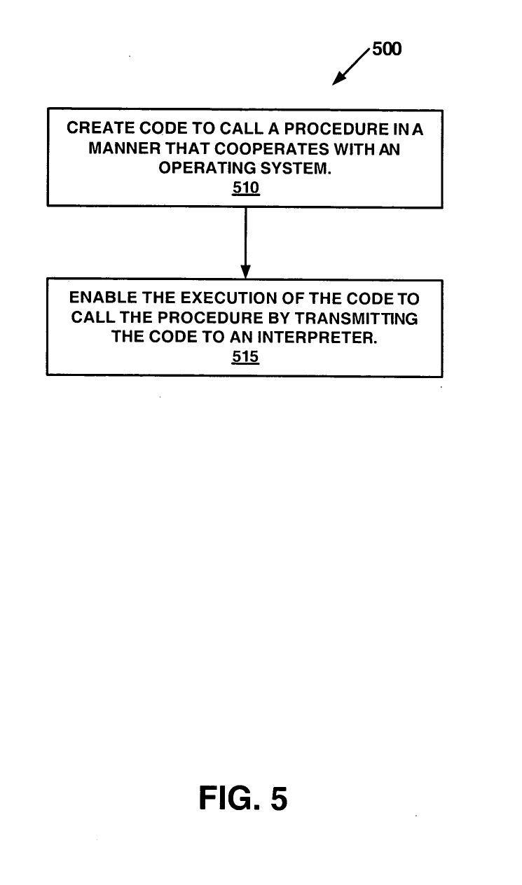

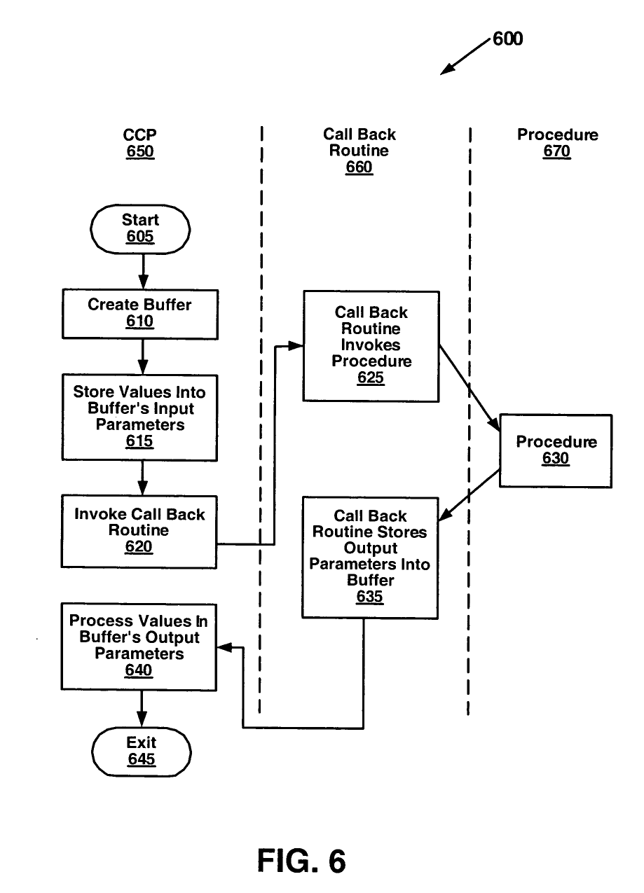

FIGS. 5 and 6 depict flowcharts 500, 600 for using code that is written in a non-native programming language to invoke a procedure 232 that is written in a native programming language, according to embodiments of the present invention. More specifically, FIG. 5 depicts a flowchart 500 for creating the CCP 224 and for enabling the execution of the CCP 224, according to one embodiment, whereas, FIG. 6 depicts a flowchart 600 that illustrates the execution of the CCP 224, according to another embodiment. Although specific steps are disclosed in flowcharts 500, 600, such steps are exemplary. That is, embodiments of the present invention are well suited to performing various other steps or variations of the steps recited in flowcharts 500, 600. It is appreciated that the steps in flowcharts 500, 600 may be performed in an order different than presented, and that not all of the steps in flowcharts 500, 600 may be performed. All of, or a portion of, the embodiments described by flowcharts 500, 600 can be implemented using computer-readable and computer-executable instructions which reside, for example, in computer-usable media of a computer system 200 or like device.

As described above, certain processes and steps of the present invention are realized, in one embodiment, as a series of instructions (e.g., software programs such as code creator 222, CCP 224, code transmitter 26, call back routine 242, procedure 232, etc.) that reside within computer readable memory of a computer system 200 and are executed by a CPU associated with computer system 200. When executed, the instructions cause the computer system 200 to implement the functionality of the present invention as described below.

For the purposes of illustration, the discussions of flowcharts 500, 600 shall refer to the structures and/or elements depicted in FIGS. 2, 3, and 4.

In step 510, code to call a procedure in a manner that cooperates with an operating system is created. For example, the CCP 224 can be created by a code creator 222 or by a program developer, as already described herein. Further, examples of code 300 and 400 can be used for creating the CCP 224. Examples of code 300 and 400 are written in a programming language, such as EFI, that is not native to the computer system 200.

More specifically the CCP 224 can be written to create a buffer from non-volatile storage. For example, the CCP 224 can be written with input parameters 320 to pass values to the procedure 232 and output parameters 330 for receiving values from the procedure 232. Further, the CCP 224 can be written with example code 400 for storing values into the buffer (e.g., example code 405) and invoking the procedure 232 (e.g., example code 410).

In step 515, the execution of the code to call the procedure is enabled by transmitting the code to an interpreter. For example, a code transmitter 226 can transmit the CCP 224 to an interpreter 244 that is associated with the operating system 240. The interpreter 244 can execute (for example by interpreting) the CCP 224, as illustrated by flowchart 600 below, which results in the procedure 232 being invoked.

Referring to FIG. 6, column 650 depicts steps 605, 610,615, 620, 640, 645 that are performed by the execution of the CCP 224, column 660 depicts steps 625, 635 that are performed by the execution of the call back routine 242, and column 670 depicts a step 630 that is performed by the execution of the procedure 232.

In step 605 of FIG. 6, the method starts. For example, the CCP 224 can be transmitted to the interpreter 244 to execute the CCP 224.

In step 610, a buffer is created. For example, as already stated, the CCP 224 can include instructions, such as that depicted in example code 300, for creating a buffer from non-volatile storage. The interpreter 244 can cause the CCP 224 to create the buffer by interpreting the instructions, such as those depicted in example code 300, for creating the buffer.

In step 615, values are stored into the buffer's input parameters. For example, as already stated, the CCP 224 can include instructions, such as that depicted in example code 405 (FIG. 4), for storing values into the input parameters 320. The interpreter 244 can cause the CCP 224 to store values into the input parameters 320 by interpreting the instructions, such as the instructions depicted in example code 405.

In step 620, the call back routine is invoked. For example, as already stated, the CCP 224 can include an instruction, such as that depicted in example code 410 (FIG. 4), for invoking a call back routine 242. The call back routine 242 can be an operating system level routine that is be pre-registered with the operating system 240.

The call back routine 242 can retrieve the values from the input parameters 320 (FIG. 3), invoke the procedure 232, which is designated by the notification value “X‘81’” (refer to example code 410), and pass the values that it retrieved from the input parameters 320 to the procedure 232.

At step 630, the procedure is invoked. For example, the procedure can retrieve values that the call back routine 242 passed to it (originating from the input parameters 320) and perform whatever processing is requested. The input parameters 320 can be used to designate the type of processing that the procedure 232 has been requested to perform. After performing the requested processing, the procedure 232 can communicate information pertaining to the requested processing by passing values back to the call back routine 242.

In step 635, the call back routine stores the values that the procedure 232 passed into the buffer's output parameters. For example, the call back routine 242 can store the values that procedure 232 passed to the call back routine 242 into output parameters 330 (FIG. 3). The call back routine 242 can return control back to code 224.

In step 640, the CCP processes the output parameters. For example, the CCP 224 can retrieve the values stored in the output parameters 330 and determine from those values what, if any, processing needs to be performed.

At step 645, processing completes.

### Conclusion

A cooperative model between the firmware 210 and the operating system 240 is provided by using a call back routine 242, among other things, that is associated with the operating system 240, to intermediate communications between the CCP 224 and the procedure 232. Thus, the firmware in non-native language 220 is enabled to communicate with the firmware in native language 230 without resulting in the computer system 200 crashing or hang.

Using a CCP 224, among other things, that conforms to the native language calling convention that the firmware in native language 230 uses enables the firmware in non-native language 220 to communicate with the firmware in native language 230 without limiting the instruction set that the CCP 224 can use for communicating with the firmware in native language 230.

What is claimed is:

1. A method of using code that is written in a non-native programming language to invoke a procedure that is written in a native programming language, the method comprising:
creating the code to call the procedure in a manner that cooperates with an operating system that the code executes on, wherein the code is written in the programming language that is not native to the computer system and the procedure is written in the programming language that is native to the computer system;
enabling the execution of the code to call the procedure by transmitting the code to an interpreter that is enabled to interpret code written in the programming language that is not native, wherein the interpreter is associated with the operating system.

2. The method as recited in claim 1, wherein the creating the code to call the procedure in the manner that cooperates with the operating system that the code executes on further comprises:
creating the code to call the procedure in the manner that cooperates with the operating system that the code executes, wherein the code is written in Advanced Configuration and Power Interface (ACPI) Machine Language (AML).

3. The method as recited in claim 2, wherein the creating the code to call the procedure in the manner that cooperates with the operating system that the code executes, wherein the code is written in Advanced Configuration and Power Interface (ACPI) Machine Language (AML) further comprises:
creating the code to call the procedure in the manner that cooperates with the operating system that the code executes, wherein an ACPI notify instruction is used to call the procedure when the code is executed.

4. The method as recited in claim 1, wherein the creating the code to call the procedure in the manner that cooperates with the operating system that the code executes on further comprises:
creating the code to call the procedure in the manner that cooperates with the operating system that the code executes on, wherein the code is written in the programming language that is not native to the computer system and the procedure is written in a programming language selected from a group consisting of Basic Input Output System (BIOS), System Abstraction Layer™ (SAL™), and Extensible Firmware Interface™ (EFI™).

5. The method as recited in claim 1, further comprising:
associating the code with a part of firmware that is written in the programming language that is not native; and
associating the procedure with a part of the firmware that is written in the programming language that is native.

6. The method as recited in claim 1, wherein the creating the code to call the procedure in the manner that cooperates with the operating system that the code executes further comprises:
creating the code to use the calling convention of the programming language that is not native so that the code can be used to call the procedure when the code is executed.

7. The method as recited in claim 1, wherein the creating the code to call the procedure in the manner that cooperates with the operating system that the code executes further comprises:
creating the code to call the procedure through a call back routine that is associated with the operating system so that the code calls the procedure in a manner that cooperates with the operating system.

8. An apparatus comprising:
a code creator for creating code to call a procedure in a manner that cooperates with an operating system that the code executes on, wherein the code is written in a programming language that is not native to the computer system and the procedure is written in a programming language that is native to the computer system;
a code transmitter for transmitting the code to an interpreter associated with the operating system, wherein the interpreter is enabled to interpret code that is written in the programming language that is not native thereby causing the code to call the procedure.

9. The apparatus of claim 8, wherein the code creator uses Advanced Configuration and Power Interface (ACPI) Machine Language (AML) to create the code.

10. The apparatus of claim 9, wherein the code creator creates the code to use an ACPI notify instruction from AML, wherein the ACPI notify instruction is used to call the procedure when the code is executed.

11. The apparatus of claim 8, wherein the procedure is written in a programming language selected from a group consisting of Basic Input Output System (BIOS), System Abstraction Layer™ (SAL™), and Extensible Firmware Interface™ (EFI™).

12. The apparatus of claim 8:
wherein the code is associated with a part of firmware that is written in the programming language that is not native; and
wherein the procedure is associated with a part of the firmware that is written in the programming language that is native.

13. The apparatus of claim 8, wherein the code creator creates the code to use the calling convention of the programming language that is not native so that the code can be used to call the procedure when the code is executed.

14. The apparatus of claim 8, wherein the creating the code to call the procedure in the manner that cooperates with the operating system that the code executes further comprises:
creating the code to call the procedure through a call back routine that is associated with the operating system so that the code calls the procedure in a manner that cooperates with the operating system.

15. A computer-usable medium having computer-readable program code embodied therein for causing a computer system to perform a method of using code that is written in a non-native programming language to invoke a procedure that is written in a native programming language, the method comprising:
creating the code to call the procedure in a manner that cooperates with an operating system that the code executes on, wherein the code is written in the programming language that is not native to the computer system and the procedure is written in the programming language that is native to the computer system;
enabling the execution of the code to call the procedure by transmitting the code to an interpreter that is enabled to interpret code written in the programming language that is not native, wherein the interpreter is associated with the operating system.

16. The computer-usable medium of claim 15, wherein the computer-readable program code embodied therein causes a computer system to perform the method, and wherein the creating the code to call the procedure in the manner that cooperates with the operating system that the code executes on further comprises:
creating the code to call the procedure in the manner that cooperates with the operating system that the code executes, wherein the code is written in Advanced Configuration and Power Interface (ACPI) Machine Language (AML).

17. The computer-usable medium of claim 16, wherein the computer-readable program code embodied therein causes a computer system to perform the method, and wherein the creating the code to call the procedure in the manner that cooperates with the operating system that the code executes, wherein the code is written in Advanced Configuration and Power Interface (ACPI) Machine Language (AML) further comprises:
creating the code to call the procedure in the manner that cooperates with the operating system that the code executes, wherein an ACPI notify instruction is used to call the procedure when the code is executed.

18. The computer-usable medium of claim 15, wherein the computer-readable program code embodied therein causes a computer system to perform the method, and wherein the creating the code to call the procedure in the manner that cooperates with the operating system that the code executes on further comprises:
creating the code to call the procedure in the manner that cooperates with the operating system that the code executes on, wherein the code is written in the programming language that is not native to the computer system and the procedure is written in a programming language selected from a group consisting of Basic Input Output System (BIOS), System Abstraction Layer™ (SAL™), and Extensible Firmware Interface™ (EFI™).

19. The computer-usable medium of claim 15, wherein the computer-readable program code embodied therein causes a computer system to perform the method, and wherein the method further comprises:
associating the code with a part of firmware that is written in the programming language that is not native; and
associating the procedure with a part of the firmware that is written in the programming language that is native.

20. The computer-usable medium of claim 15, wherein the computer-readable program code embodied therein causes a computer system to perform the method, and wherein the creating the code to call the procedure in the manner that cooperates with the operating system that the code executes further comprises:
creating the code to use the calling convention of the programming language that is not native so that the code can be used to call the procedure when the code is executed.

21. The computer-usable medium of claim 15, wherein the computer-readable program code embodied therein causes a computer system to perform the method, and wherein the creating the code to call the procedure in the manner that cooperates with the operating system that the code executes further comprises:
creating the code to call the procedure through a call back routine that is associated with the operating system so that the code calls the procedure in a manner that cooperates with the operating system.
